(19) United States
(12) Patent Application Publication
(10) Pub. No.: US 2024/0275248 A1
(43) Pub. Date: Aug. 15, 2024

(54) METHOD FOR PRODUCING A PERMANENT MAGNET FOR AN ELECTRICAL MACHINE, PERMANENT MAGNET AND USE OF A PERMANENT MAGNET

(71) Applicant: MERCEDES-BENZ GROUP AG, Stuttgart (DE)

(72) Inventors: Mike FUCHSLOCHER, Stuttgart (DE); Hristian NAUMOSKI, Altbach (DE); Thomas ALBRECHT, Memmingerberg (DE); Moritz KILPER, Rutesheim (DE); Andreas BÜNTING, Stuttgart (DE); Hermann PFEIFER, Langenau (DE); Tim ZIEGLER, Schopfloch (DE); Torben SCHULZE, Adelberg (DE)

(21) Appl. No.: 18/568,315

(22) PCT Filed: May 19, 2022
(86) PCT No.: PCT/EP2022/063524

§ 371 Date: Dec. 8, 2023

(30) Foreign Application Priority Data
Jun. 9, 2021 (DE) 10 2021 002 942.9

(51) Int. Cl. H02K 15/12; H01F 41/02; H02K 1/27

(52) U.S. Cl. CPC H02K 15/12; H01F 41/0266; H01F 41/0286; H02K 1/27

(57) ABSTRACT

At least one permanent magnet for an electrical machine is produced by first producing a permanently magnetic base body by compression molding or extrusion. A first partial region of the base body is separated from at least one second partial region of the base body by a cutting process. At least one permanent magnet is provided by the first partial region. The at least one permanent magnet is provided with a cavity by the cutting process.

### BACKGROUND AND SUMMARY OF THE INVENTION

Exemplary embodiments of the invention relate to a method for producing at least one permanent magnet for an electrical machine, in particular a motor vehicle, as well as to a permanent magnet for an electrical machine and to the use of a permanent magnet.

DE 100 27 086 A1 discloses a magnetic element cutting process having a first step of preparing a cutting blade with a cutting edge, which has an abrasive grain and a heat-resistant resin. The magnetic element cutting process has a second step of cutting a magnetic element by the cutting blade, while a temperature-controlled coolant is guided into a cutting area. A method for cutting a rare earth metal alloy by using a wire with abrasive grains is known from DE 101 57 433 A1. Furthermore, WO 03/074229 A1 discloses a method for cutting a rare earth metal alloy. Furthermore, a segmented magnet is known from DE 10 2017 200 142 A1.

Exemplary embodiments of the present invention are directed to a method for producing at least one permanent magnet for an electrical machine, in particular a motor vehicle, a permanent magnet for an electrical machine, in particular a motor vehicle, and the use of a permanent magnet, so that the permanent magnet can be produced particularly time-efficiently and cost-effectively.

A first aspect of the invention relates to a method for producing at least one permanent magnet for an electrical machine, in particular a motor vehicle. This means that the motor vehicle preferably formed as an automobile, in particular as a passenger car, has the electrical machine in its completely produced state and is electrically drivable, in particular is purely electrically drivable, by means of the electrical machine. Therefore, the motor vehicle is preferably a hybrid vehicle or electric vehicle, in particular a battery electric vehicle (BEV). Preferably, the electrical machine is formed as a high-voltage component, whose electrical voltage, in particular electrical operating voltage, or rated voltage, is preferably greater than 50 volts, in particular greater than 60 volts, and amounts very preferably to several hundred volts. Therefore, particularly great electrical power for the, in particular purely, electrical powering of the motor vehicle can be achieved. Preferably, the electrical machine is an axial flux machine, which has an axial air gap. This means in particular the following: The axial flux machine has a stator and at least one rotor, which is rotatable around an axis of rotation in relation to the stator. Therefore, an air gap is arranged between the stator and the rotor, wherein the air gap is arranged in an axial direction of the axial flux machine, i.e., as viewed along the axis of rotation between the stator and the rotor. In other words, the stator and the rotor are arranged in an axial direction of the axial flux machine next to each other or consecutively. In particular, the axial flux machine can have a double rotor, i.e., two rotors, which are arranged preferably coaxially to each other. The rotors are rotatable around the axis of rotation in relation to the stator. In this case, the stator is arranged, for example, in an axial direction of the axial flux machine between the rotors, in particular in such a way that an air gap is arranged in the axial direction of the axial flux machine between the stator and each rotor, respectively. In particular, the axial flux machine can provide torques by way of its rotor for powering the motor vehicle.

In a first step of the method, a permanently magnetic base body, i.e., a permanent magnet base body, is produced by compression molding or extrusion. In other words, during the first step of the method, a compression molding process or an extrusion process is carried out, wherein the permanent magnet base body is produced by means of the compression molding process or by means of the extrusion process. In particular, the permanently magnetic (permanent magnet) base body is produced from a molding composition, which is processed, i.e., is pressed, during the compression molding or extrusion. Preferably, the molding composition is a molten material, therefore a melt made from the material from which the base body is produced. The molding composition or the melt is formed by the compression molding or extrusion. The molding composition can have a plastic and permanently magnetic particles embedded in the plastic, or the material or the molding composition itself is permanently magnetic. By means of the compression molding or the extrusion, the base body can be produced particularly time-efficiently or cost-effectively.

In a second step of the method which preferably follows the first step of the method, in particular, at least or exactly one first partial region of the base body is separated, i.e., cut off, from at least one second partial region of the base body by a cutting process, in particular by jet cutting. In other words, during the second step of the method, a cutting process, in particular a jet cutting process, is carried out. During the jet cutting or the jet cutting process, at least or exactly one cutting jet, also simply referred to as a jet, is provided, by means of which the first partial region is separated or cut off from the second partial region of the base body. For example, the cutting jet is applied to the base body and, in other words, the base body is acted upon by the cutting jet, in such a way that by means of the cutting jet the first partial region is separated, i.e., cut off, from the second partial region. The cutting jet can be, for example, an energy beam, in particular an electronic beam or a laser beam. However, it has proved to be particularly advantageous if the cutting jet is a fluid jet, i.e., is formed by a fluid, for example by a liquid. In particular, the cutting jet is provided along a jet direction, for example from a cutting tool, also described as a tool, particularly in such a way that the cutting jet along the jet direction impinges on the base body or the base body along the jet direction is acted upon by the cutting jet. For example, the cutting jet is moved along a separation or cutting direction in relation to the base body. For example, the separation direction extends in a plane, with it being conceivable that the jet direction extends at an angle or perpendicular to the plane. During the second step of the method, the at least one permanent magnet is provided by the first partial region. In other words, the first partial region is used as the at least one permanent magnet. Again, stated in other words, the at least one permanent magnet is produced by separating the first partial region, which forms or provides the at least one permanent magnet, from the second partial region. As a result of the jet cutting, the first partial region can be separated from the second partial region particularly time-efficiently and cost-effectively, and as a result of the jet cutting, a customized, in particular outer circumferential, shape or geometry of the first partial region and therefore of the at least one permanent magnet can be produced in a particularly time-efficient and cost-effective manner.

In a third step of the method, the at least one permanent magnet, in particular a surface or an outer circumferential lateral surface of the at least one permanent magnet, is provided with, in particular at least or exactly, one, particularly continuous or uninterrupted, cavity by the cutting process. The cutting process or the cutting jet therefore is also used to produce the cavity of the at least one permanent magnet, i.e., for example, the cavity in the surface or the outer circumferential lateral surface of the at least one permanent magnet. Therefore, as the cutting process is used equally to separate the first partial region from the second partial region as well as to produce the cavity, the at least one permanent magnet can be produced particularly time-efficiently and cost-effectively and can therefore also be provided with the cavity. Due to the cavity, i.e., by producing the cavity, in particular during an operation of the electrical machine eddy current losses can be kept particularly low, so that a particularly efficient operation is feasible in a particularly cost-effective manner.

The invention is based in particular on the following findings: In order to be able to keep the eddy current losses sufficiently low in magnets, in particular formed as permanent magnets, of electrical machines, axial flux machines, typically thin, individual magnets are used. For example, the thin, individual magnets are each stacked on top of one another or arranged on one another as individual, thin layers, and the permanently magnetic layers stacked on one another or arranged on one another are packaged, i.e., connected to one another, whereby a stable, permanently magnetic, i.e., permanent magnetic package can be created. The permanently magnetic package is used from the permanently magnetic overall magnet. It is conceivable in this case to equip the axial flux machine with multiple such permanently magnetic packages. The packaging is carried out for example such that the individual, thin magnets, i.e., the layers, are connected to one another by means of an adhesive, i.e., glued to one another. Typically, for the production of the permanently magnetic overall magnet, a large number of process steps and therefore a long process time are required so that the permanently magnetic overall magnet can only be produced in a very time-consuming and costly manner. For example, the layers are individual sheets, i.e., formed from a sheet, in particular an electrical steel sheet, whereby the layers are connected with one another. This connection or the packaging of the layers is time-intensive and requires additional connection technology, like for example bonding or an adhesive, in order to connect the layers with one another. If, for example, an outer circumferential shape different from a rectangular shape or from a cuboid shape, such as a trapezoidal shape, of the magnet as a whole is to be produced, usually different layers, i.e., layers with different shapes, have to be stacked on one another, so that the layers themselves have to be produced in a very time-consuming and costly manner.

The previously mentioned problems and disadvantages can be avoided by the invention. On the one hand, the base body can be produced particularly time-efficiently and cost-effectively. On the other hand, the first partial region can be separated from the second partial region particularly time-efficiently and cost-effectively, whereby during the separation or by the separation, in particular simultaneously, a desired, outer circumferential shape of the at least one permanent magnet can be produced. Therefore, the shape of the permanent magnet and thus the permanent magnet as a whole can be produced particularly time-efficiently and cost-effectively, as the permanent magnet can be provided with the cavity particularly time-efficiently and cost-effectively by the cutting process.

In order to be able to produce the at least one permanent magnet particularly time-efficiently and cost-effectively, it is provided by an embodiment of the invention that jet cutting, in particular water jet cutting, is used as the cutting process. The cutting jet is therefore preferably a water jet, i.e., at least predominantly, in particular exclusively, formed from water.

A further embodiment is characterized in that the separation of the first partial region from the second partial region and the provision of the at least one permanent magnet with the cavity is carried out in a single step, i.e., uninterrupted. This is to be understood to mean that there is no interruption of the cutting process between the separation of the first partial region from the second partial region and the provision of the at least one permanent magnet with the cavity. Again, in other words, it is provided that the base body does not stop being acted upon by the cutting jet between the separation of the first partial region from the second partial region and the provision of the at least one permanent magnet with the cavity. Again, stated in other words: The cutting jet is provided, in particular, by the previously mentioned tool and in particular applied or irradiated onto the base body, in order thereby to separate the first partial region from the second partial region and to create the cavity, therefore to provide the at least one permanent magnet with the cavity. In this case, it is preferentially provided that the cutting jet does not stop being provided between the separation of the first partial region from the second partial region and the provision of the at least one permanent magnet with the cavity, so that preferentially the cutting jet is provided continuously, i.e., uninterrupted, from the beginning of the separation of the first partial region from the second partial region until the end of the provision of the at least one permanent magnet with the cavity and in particular the cutting jet is irradiated continuously, i.e., uninterrupted, onto the base body, i.e., onto the first partial region and/or the second partial region. Therefore, the separation of the first partial region from the second partial region and the provision of the at least one permanent magnet with the cavity take place at least substantially continually, i.e., in one and the same, in particular continuous process, whereby the at least one permanent magnet can be produced as a whole particularly time-efficiently and cost-effectively.

In a further, particularly advantageous embodiment of the invention it is provided that the cavity is produced as a blind hole. This is to be understood to mean that the cavity is not produced as a through opening that completely penetrates the at least one permanent magnet, rather the cavity is produced in such a way that, like a blind hole, it is not completely continuous along the jet direction, but instead it is bounded by a remaining wall region of the at least one permanent magnet along the jet direction.

Alternatively, it has been proven to be advantageous when the cavity is produced as a through opening that completely penetrates the at least one permanent magnet, in particular as a passage slot. Therefore, eddy current losses can be maintained particularly low in the at least one permanent magnet and in a particularly cost-effective manner.

In order to produce the permanent magnet particularly time-efficiently and cost-effectively and therefore to be able to keep the eddy current losses particularly low, it is provided in a further design of the invention that the cavity extends in an arched, in particular meandering, manner. This is to be understood to mean, in particular, that the cavity extends at least in a longitudinal region in an arched, in particular in a meandering manner. It is conceivable that, for example, the cavity is bent at least in a second longitudinal region, in particular in such a way that, for example, a first part of the second longitudinal region and a second part of the second longitudinal region each extend in a straight line, wherein preferably the second part is directly joined to the first part, and wherein it is preferably provided that the first part and the second part form an angle different from 0 and from 180° with one another, therefore extending diagonally or perpendicularly to one another. This is a particularly good way to avoid excessive eddy current losses.

A further embodiment is characterized in that the at least one permanent magnet, in particular on the outer periphery, is produced in the shape of a triangle. As a result, a particularly advantageous shape of the permanent magnet, in particular on the outer periphery, can be produced in a particularly cost-effective and time-efficient manner, whereby the eddy current losses can be kept particularly low.

In an additional, particularly advantageous embodiment of the invention, it is provided that the base body is produced as a cuboid, i.e., as a rectangular or cuboid block. Thus, the base body and therefore the at least one permanent magnet as a whole can be produced particularly time-efficiently and cost-effectively.

A further embodiment is characterized in that the base body, in particular on the outer periphery, is produced in the shape of a trapezium. As a result, a particularly advantageous outer peripheral shape of the at least one permanent magnet can be produced in a particularly time-efficient and cost-effective manner, so that, for example, the at least one permanent magnet can be or is connected with a positive fit to a carrier of the electrical machine in a particularly simple and cost-effective manner.

Lastly, it has proved to be particularly advantageous when at least one positive-locking element of the at least one permanent magnet is produced, which can be or is connected by means of the positive-locking element with a positive fit to the carrier of the electrical machine. For example, the positive-locking element is produced by the compression molding or by the extrusion. Alternatively, or additionally, the positive-locking element can be produced by the cutting process. The at least one permanent magnet can therefore be provided in a particularly time-efficient and cost-effective manner with the positive-locking element, so that additional, subsequent process steps for producing the positive-locking element or a positive-locking element can be avoided. The positive-locking element can be used in order to connect the permanent magnet particularly advantageously with the carrier, i.e., to hold it on the carrier. Overall, the at least one permanent magnet can be produced particularly time-efficiently and cost-effectively, so that a particularly time-efficient and cost-effective production of the electrical machine is feasible.

A second aspect of the invention relates to a permanent magnet for an electrical machine, in particular for an axial flux machine, wherein the permanent magnet according to the second aspect of the invention is produced by means of a method according to the first aspect of the invention. Advantages and advantageous embodiments of the first aspect of the invention are to be regarded as advantages and advantageous embodiments of the second aspect of the invention and vice versa.

A third aspect of the invention relates to the use of a permanent magnet according to the second aspect of the invention, wherein the permanent magnet is used for an electrical machine, formed as an axial flux machine. Advantages and advantageous embodiments of the first and second aspects of the invention are to be regarded as advantages and advantageous embodiments of the third aspect of the invention and vice versa.

Preferably, the permanent magnet is used for one or the rotor of the axial flux machine, so that in the completely produced state of the axial flux machine, the permanent magnet and preferably the aforementioned carrier is or are a part or parts of the rotor of the axial flux machine.

In comparison to conventional solutions, in particular the following advantages can be achieved by the invention:
smaller cutting length
lower number of process steps
reduced process times

Due to the cutting process, a particularly advantageous and customized contour of the cavity can be produced in a particularly time-efficient and cost-effective manner. For example, the cavity at least in a longitudinal region of the cavity can extend in a serpentine or wave shape, whereby eddy current losses can be kept particularly low.

It has proved to be particularly advantageous when a second permanent magnet is provided by the second partial region of the base body. In other words, it is conceivable that the second partial region of the base body is also used as a second permanent magnet for the electrical machine, in particular an axial flux machine. In this case, it has been proven to be particularly advantageous when the second permanent magnet is also provided with at least or exactly one second cavity by the cutting process during the third step of the method. The preceding and following embodiments for the at least one permanent magnet and for the first cavity can be readily transferred to the second permanent magnet and the second cavity and vice versa. The method according to the invention enables therefore the production of a high number of permanent magnets for an electrical machine, in particular for an axial flux machine, in a particularly time-efficient and cost-effective manner and in particular enables these permanent magnets to be provided with the cavities, so that the eddy current losses can be kept particularly low.

Further advantages, features and details of the invention result from the description of preferred exemplary embodiments below, as well as by means of the drawing. The features and feature combinations referred to above in the description as well as the features and feature combinations referred to below in the description of the figures and/or shown solely in the figures can be used not only in each specified combination but also in other combinations or alone without leaving the scope of the invention.

### BRIEF DESCRIPTION OF THE DRAWING FIGURES

In the drawing:

FIG. 1 shows a schematic representation of a first part of a method for producing at least one permanent magnet according to a first embodiment for an electrical machine, in particular formed as an axial flux machine;

FIG. 2 shows a schematic representation of a second part of the method according to FIG. 1;

FIG. 3 shows a schematic perspective view of the permanent magnet according to its second embodiment, before the permanent magnet is provided with a cavity;

FIG. 4 shows a schematic perspective view of the permanent magnet provided with the cavity according to the second embodiment;

FIG. 5 shows a schematic top view of the permanent magnet according to its third embodiment;

FIG. 6 shows a schematic cross-sectional side view of the permanent magnet according to FIG. 5;

FIG. 7 shows a schematic top view of the permanent magnet according to its fourth embodiment;

FIG. 8 shows a schematic cross-sectional side view of the permanent magnet according to the fourth embodiment;

FIG. 9 shows a further schematic top view of the permanent magnet according to the third embodiment;

FIG. 10 shows a schematic front view of a die for the extrusion of a base body for the production of the permanent magnet;

FIG. 11 shows a schematic front view of the base body, from which the permanent magnet is produced according to its fifth embodiment;

FIG. 12 shows a schematic front view of the base body, from which the permanent magnet is produced according to its sixth embodiment;

FIG. 13 shows a schematic front view of the base body, from which the permanent magnet is produced according to a sixth embodiment; and

FIG. 14 shows a schematic front view of the base body, from which the permanent magnet is produced according to the fifth embodiment.

In the figures, the same or functionally identical elements are provided with the same reference numerals.

### DETAILED DESCRIPTION

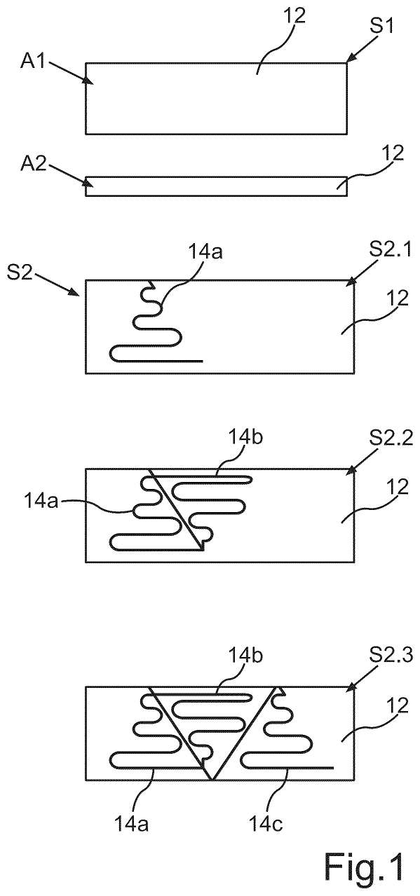

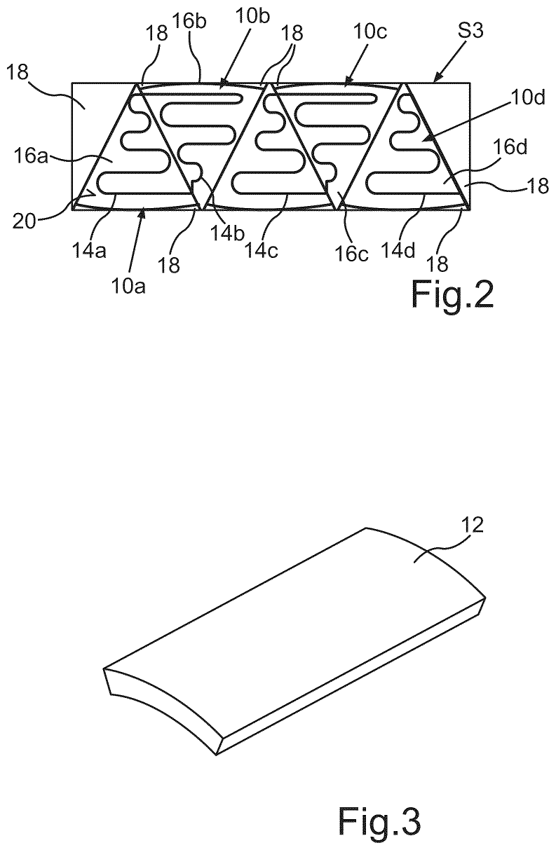

Based on FIGS. 1 and 2, a method for producing permanent magnets 10a-d according to a first embodiment for an electrical machine formed as an axial flux machine is described hereinafter. This means that the permanent magnets 10a-d are used in the aforementioned axial flux machine, i.e., are components of the axial flux machine in the completely produced state of the axial flux machine. In particular, the permanent magnets 10a-d are used for a rotor of the axial flux machine, so that in the completely produced state of the axial flux machine, the permanent magnets 10a-d are components of the rotor of the axial flux machine.

In a first step S1 of the method, a permanently magnetic i.e., a permanent magnet base body 12 is produced by compression molding or extrusion. The permanently magnetic base body 12 is shown in FIG. 1 in a schematic top view labelled A1 and in a schematic side view labelled A2. It is apparent that in the case of the first embodiment, the permanently magnetic base body 12 is produced as a rectangular or cuboid-shaped, in particular solid, block by compression molding or preferably by extrusion. FIG. 1 shows furthermore sub-steps S2.1, S2.2 and S2.3 of a second step S2 of the method. During the second step S2 of the method, in particular following the first step S1, the base body 12 and therefore the permanent magnets 10a-d, which are produced from the preferably extruded, permanently magnetic base body 12, are provided with cavities 14a-d, also referred to as contours or having a respective contour, by an cutting process presently embodied as jet cutting, in particular in such a way that the permanently magnetic base body 12 is provided with the cavities 14a-d in such a way that the permanent magnet 10a is provided with the cavity 14a, the permanent magnet 10b is provided with the cavity 14b, the permanent magnet 10c is provided with the cavity 14c and the permanent magnet 10d is provided with the cavity 14d, thus the respective permanent magnet 10a-d is provided with at least or exactly one of the respective cavities 14a-d. During a third step S3 of the method, for example following the second step S2, partial regions 16a-d of the base body 12 are each separated from one another and preferably also from at least or exactly one other partial region or from several, other partial regions of the base body 12 by jet cutting, wherein the permanent magnets 10a-d are provided by the partial regions 16a-d in such a way that the permanent magnet 10a is provided by the partial region 16a, the permanent magnet 10b is provided by the partial region 16b, the permanent magnet 10c is provided by the partial region 16c and the permanent magnet 10d is provided by the partial region 16d. In other words, the partial regions 16a-d of the base body 12 are used as the permanent magnets 10a-d. In particular, it is provided during the third step S3 that the partial regions 16a-d and therefore the permanent magnets 10a-d are cut to shape by the jet cutting and thereby in particular are produced or provided with an outer circumferential shape or contour or geometry. The respective other partial region of the base body 12 is also referred to as an offcut and is labelled in FIG. 2 with 18, so that the partial regions 16a-d are separated, i.e., cut off, from one another and from the offcut by the jet cutting. In the completely produced state of the permanent magnets 10a-d, which are also simply referred to as magnets, the magnets are individual magnets, thus separately formed components, and in the completely produced state of the permanent magnets 10a-d, the permanent magnets 10a-d have the cavities 14a-d. The respective, completely produced permanent magnet 10a-d is therefore a jet-cut and extruded magnet, whereby in particular the following advantages can be achieved:
elimination of additional connecting technology
smaller cutting length
lower number of process steps
reduced process times

The permanent magnets 10a-d can be produced therefore particularly time-efficiently and cost-effectively. Due to the provision of the permanent magnets 10a-d with the cavities 14a-d, eddy current losses in the permanent magnets 10a-d can additionally be kept particularly low.

Advantageously, the jet cutting is carried out with optimized cutting lengths. It has furthermore proven to be particularly advantageous when water jet cutting is used for the jet cutting. During the jet cutting it is, in particular, provided that a cutting tool, also referred to for example as a tool, provides and therefore radiates a cutting jet, also referred to as a jet, in particular along a jet direction. Preferably, the cutting jet is formed from a liquid, for example containing at least water, and therefore as a liquid jet, in particular as a water jet, wherein for the separation of the partial regions 16a-d and for the production of the cavities 14a-d, the cutting jet is radiated for example along the jet direction on the base body 12, meaning that it is radiated onto the respective partial region 16a-d and/or 18. Furthermore stated in other words, for example during the production of the cavity 14a-d and during the separation of the partial regions 16a-d, the base body 12 is acted upon by the cutting jet, in particular along the jet direction.

Preferably, it is provided that the separation of the partial regions 16a-d from one another and from the respective other partial region 18 and the provision of the base body 12 and therefore the permanent magnets 10a-d with the cavities 14a-d is carried out in one step, i.e., uninterrupted, so that between the separation of the partial regions 16a-d from one another and from the respective partial region 18 and the provision of the base body 12 with the cavities 14a-d, an interruption of the jet cutting, i.e., an end to the provision of the cutting jet by the tool is omitted.

It is particularly recognizable from FIGS. 1 and 2 that the respective cavity 14a-d at least substantially extends in a meandering manner. The respective cavity 14a-d is therefore a cavity of a respective surface 20 or of a respective outer circumferential lateral surface of the respective permanent magnet 10a-d. Furthermore, it is recognizable from FIG. 2 that the respective permanent magnet 10a-d is produced in the shape of a triangle, i.e., in its completely produced state it has a triangular shape. In the exemplary embodiment shown in FIGS. 1 and 2 it is provided that the respective permanent magnet 10a-d has the shape of a triangle, wherein two sides of the triangle are formed straight, and the third side of the triangle is arched, in particular circularly arched.

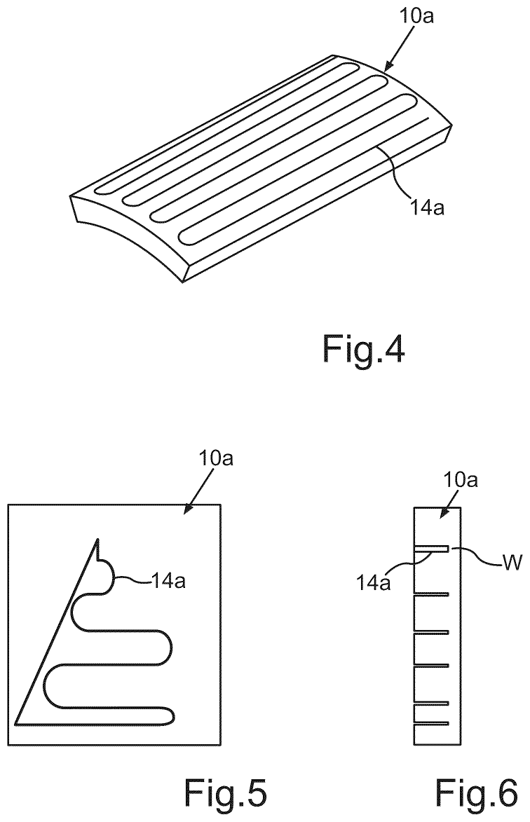

FIG. 3 shows the permanently magnetic base body 12, from which the permanent magnet 10a shown in FIG. 4 is produced according to the second embodiment. The base body 12 is produced by extrusion, so that the base body 12 is an extruded profile, in particular a solid extruded profile. In particular, it is preferably provided that the base body 12 is formed as a single piece. The base body 12 is provided with the cavity 14a which, as is recognizable from FIG. 4, extends in a meandering manner.

FIGS. 5 and 6 show a third embodiment of the permanent magnet 10a. From FIGS. 5 and 6 it is particularly clearly recognizable that the cavity 14a, for example, is produced as a blind hole or in the manner of a blind hole, so that the cavity 14a does not penetrate the permanent magnet 10a completely along the jet direction, but instead is restricted by a wall region W of the permanent magnet 10a.

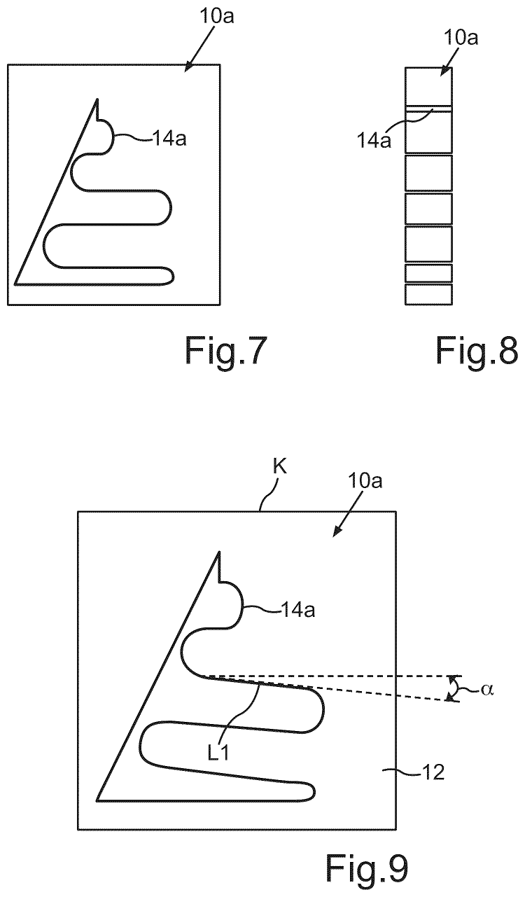

FIGS. 7 and 8 show a fourth embodiment of the permanent magnet 10a. In the fourth embodiment the cavity 14a is formed as a through opening or in the manner of a through opening, which completely penetrates the permanent magnet 10a. It is particularly clearly recognizable from FIGS. 5 to 8 that the permanent magnet 10a is provided with exactly one cavity 14a by the jet cutting, wherein the cavity 14a extends continuously, i.e., uninterrupted. Therefore, for example for the production of the third embodiment, the jet cutting is carried out as a cutting-in method, in order to produce the cavity 14a as a blind hole or in the manner of a blind hole. For the production of the fourth embodiment, the jet cutting is carried out as a cutting-through method, by means of which the cavity 14a is formed as a through opening.

It is conceivable that as the cutting process, by means of which the partial regions 16a-d are separated from one another and from the offcut and the permanent magnets 10a-d are provided with the cavities 14a-d, laser cutting, i.e., a laser cutting process, is used so that the cutting jet is an energy jet or a laser jet. Furthermore, it is conceivable that wire cutting EDM is used as the cutting process. In particular by using wire cutting EDM as the cutting process, the cutting process can be carried out in a particularly advantageous manner as the previously described cutting-through method, whereby for example the cavity 14a can be particularly advantageously produced as a through opening.

FIG. 9 shows another schematic top view of the permanent magnet 10a-d according to the third embodiment. It is recognizable that the cavity 14a can have at least or exactly two straight-line longitudinal regions extending diagonally or perpendicular to one another. Alternatively, or additionally, the arched, in particular meandering, cavity 14a can have longitudinal regions. In particular, the cavity 14a is formed by at least or exactly one cutting line, which is produced by the cutting process. The cutting line can extend in at least one first longitudinal region horizontally and/or at least one second longitudinal region at an angle. In other words, respective longitudinal regions of the cavity 14a can be arranged at an arbitrary angle, in particular to one another. In FIG. 9, an angle is labelled with a, which is enclosed by a longitudinal region, labelled L and substantially at least extending in a straight line, of the cavity 14a and an edge K, in particular formed as a cutting edge, of the base body 12.

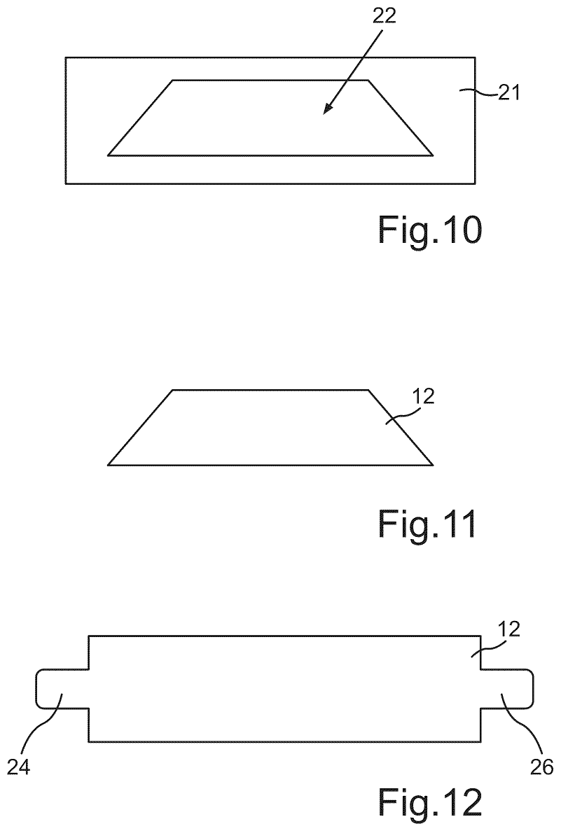

FIG. 10 shows a die 21 in a schematic front view, which is produced during the extrusion and therefore for the extrusion of the base body 12. FIG. 11 shows a fifth embodiment of the base body 12, which is produced by means of the die 21 according to FIG. 10. The die 21 has an opening 22, through which a semi-finished product, from which the base body 12 according to FIG. 11 is produced, is forced. From FIG. 11 it is recognizable that the base body 12 according to the fifth embodiment, in particular in relation to its cross section, has the shape of a trapezium.

FIG. 12 shows a sixth embodiment of the base body 12. In the sixth embodiment, the base body 12 has positive-locking elements 24 and 26, wherein preferably the permanent magnet 10, which is produced from the base body 12, has the positive-locking elements 24 and 26 in its completely produced state. The respective positive-locking element 24 or 26 is, for example, a tongue and groove element, which is arrangeable in a corresponding receiver, formed, for example, as a groove, of a carrier of the axial flux machine, in such a way that the permanent magnet 10a can be connected with a positive fit to the carrier, i.e., can be attached to the carrier, by means of the positive-locking elements 24 and 26. The positive-locking elements 24 and 26 are for example produced by the extrusion and/or the cutting process.

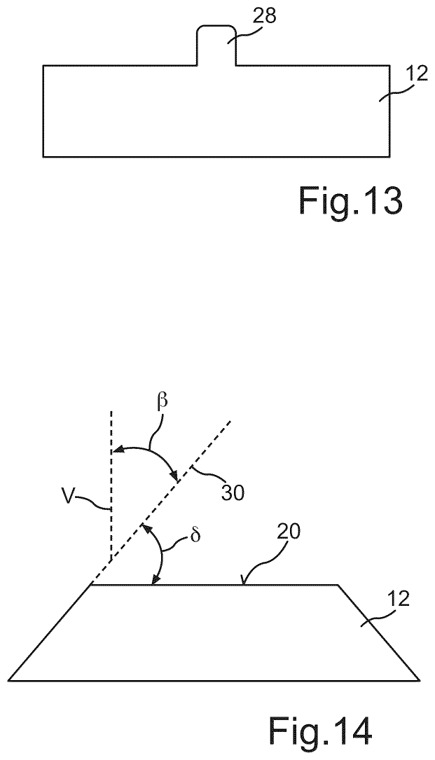

FIG. 13 shows the base body 12 according to a seventh embodiment. In the seventh embodiment as well, the base body 12 and the permanent magnet 10a, which is produced from the base body 12, have a positive-locking element 28, which, for example, can be formed as a tongue and groove element. Therefore, the preceding and following embodiments for the respective positive-locking elements 24 or 26 are transferable to the positive-locking element 28 and vice versa. Usually, in electrical machines, magnets are connected with a carrier such as a rotor core of the rotor of the electrical machine by adhesive bonds. The adhesive bonds and the magnets are exposed to high, critical temperatures and loads. The respective positive-locking element 24, 26 or 28 makes it possible to connect the respective permanent magnets 10a-d to the carrier, like, for example, the rotor core, not or not only in an integral manner, but the respective permanent magnet 10a-d can be connected with a positive fit by means of the respective positive-locking element 24, 26 or 28 to the carrier formed in particular as a rotor core. Therefore, a particularly secure mechanical fixing of the respective permanent magnet 10a-d on the carrier can be achieved. In particular, the respective permanent magnet 10a-d can be mechanically connected with a positive fit by means of the respective positive-locking element 24, 26 or 28 to the carrier, whereby particularly high forces or torques can be transferred. Also, the trapezium shape of the base body 12 and particularly of the fully produced permanent magnet 10a-d shown in FIG. 11 enables a particularly advantageous positive-fit attachment of the respective permanent magnet 10a-d to the carrier.

FIG. 14 shows another schematic front view of the base body 12 according to the fifth embodiment. In FIG. 14, the cutting jet is labelled 30. In the embodiment shown in FIG. 14, the cutting jet 30 is a water jet. It is recognizable that the cutting jet 30 or the jet direction thereof forms an angle β with the vertical V, which is different from 0° and from 180° and in particular less than 90°. At the angle β, the base body 12 is acted upon with the cutting jet 30. It is recognizable that the cutting jet 30 or the jet direction thereof forms another angle δ with a surface 20 of the base body 12, whose surface 20 is acted upon with the cutting jet 30, wherein the angle β and the angle δ add up to 90°. The angles β and δ can be the same size or different sizes from one another. This produces the trapezoidal shape of the base body 12 and therefore of the permanent magnet 10a-d. In particular, the trapezium shape makes it possible to attach the permanent magnets 10a-d with a mechanically positive fit to the carrier.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10a-d Permanent magnet
12 Base body
14a-d Cavity
16a-d Partial region
18 Other partial region
20 Surface
21 Die
22 Opening
24 Positive-locking element
26 Positive-locking element
28 Positive-locking element
30 Cutting jet
K Edge
L1 Longitudinal region
A1 Top view
A2 Side view
S1 First step
S2 Second step
S2.1 Sub-step
S2.2 Sub-step
S2.3 Sub-step
S3 Third step
V Vertical
W Wall region
α Angle
β Angle
δ Angle

1-10. (canceled)

11. A method for producing at least one permanent magnet for an electrical machine, the method comprising:
producing a permanently magnetic base body by compression molding or extrusion;
separating a first partial region of the base body from at least one second partial region of the base body by a cutting process, wherein the at least one permanent magnet is provided by the first partial region; and
providing the at least one permanent magnet with a cavity by the cutting process,
wherein the separation of the first partial region from the second partial region and the provision of the at least one permanent magnet with the cavity are carried out in a single step.

12. The method of claim 11, wherein the cutting process uses jet cutting.

13. The method of claim 12, wherein the jet cutting is water jet cutting.

14. The method of claim 11, wherein the cavity is a blind hole.

15. The method of claim 11, wherein the cavity is a through opening.

16. The method of claim 11, wherein the cavity extends in meandering manner.

17. The method of claim 11, wherein the at least one permanent magnet is produced in a shape of a triangle.

18. The method of claim 11, wherein the base body is produced as a cuboid or in a shape of a trapezium.

19. The method of claim 11, wherein the at least one permanent magnet includes at least one positive-locking element configured to so that the at least one permeant magnet is connected by the positive-locking element with a positive fit to a carrier of the electrical machine.

20. A permanent magnet for an electrical machine, wherein the permanent magnet is produced by:
producing a permanently magnetic base body by compression molding or extrusion;
separating a first partial region of the base body from at least one second partial region of the base body by a cutting process, wherein the at least one permanent magnet is provided by the first partial region; and
providing the at least one permanent magnet with a cavity by the cutting process,
wherein the separation of the first partial region from the second partial region and the provision of the at least one permanent magnet with the cavity are carried out in a single step.
